(19) United States
(12) Patent Application Publication
(10) Pub. No.: US 2024/0367482 A1
(43) Pub. Date: Nov. 7, 2024

(54) METHOD FOR OPERATING CABIN AIR FILTRATION SYSTEM OF VEHICLE, ELECTRONIC CONTROL UNIT AND CABIN AIR FILTRATION SYSTEM

(71) Applicant: MANN+HUMMEL GmbH, Ludwigsburg (DE)

(72) Inventors: Bernd BAUER, Stadelhofen (DE); Maximilian BAUCH, Bönnigheim (DE); Frank PFLÜGER, Sachsenheim (DE)

(21) Appl. No.: 18/777,530

(22) Filed: Jul. 18, 2024

Related U.S. Application Data
(63) Continuation of application No. PCT/EP2023/053029, filed on Feb. 8, 2023.

(30) Foreign Application Priority Data
Feb. 17, 2022 (EP) 22157253.0

(51) Int. Cl. B60H 1/00; B60H 3/06

(52) U.S. Cl. CPC B60H 1/008; B60H 1/00849; B60H 3/0625; B60H 2003/0683

(57) ABSTRACT

A method for operating a cabin air filtration system of a vehicle includes retrieving, from a storage of a filter element, data comprising information characterizing the filter element, providing system information for the filter element identified by the retrieved data, retrieving current air property data referring to an air property inside and/or outside a cabin, and determining a current air quality information about a current air quality inside the cabin, from the system information for a current magnitude of an air flow, a current recirculation ratio of fresh air and recirculated air and the current air property data.

### CROSS-REFERENCE TO RELATED APPLICATIONS

This application is a continuation application of International Application No. PCT/EP2023/053029 filed on Feb. 8, 2023, which claims the benefit of European Application No. 22157253.0 filed on Feb. 17, 2022, the entire disclosures of which are incorporated herein by reference for all purposes.

### BACKGROUND

Embodiments to a method for operating a cabin air filtration system of a vehicle, wherein the cabin air filtration system comprises an air filter device for filtering an air flow into the cabin, which air flow is composed of fresh air from outside and recirculated air from inside the cabin, wherein a magnitude of the air flow through the air filter device is adjustable and wherein a ratio of fresh air and recirculated air of the air flow through the air filter device is adjustable.

Such a cabin air filtration system is known from WO 2018/224299 A1. The system according to WO 2018/224299 A1 comprises three filter elements some of which can selectively be bypassed. Furthermore, a ratio of fresh air and recirculated air is adjustable.

Generally, the use of several filter elements allows for a significant increase of air quality inside the cabin, in particular in highly polluted environments. Using higher amounts of recirculated air may contribute to enhance the air quality inside the cabin. Furthermore, by selectively bypassing some of the filter elements, in particular in less polluted environments, the service life of the filter elements can be increased. Bypassing some of the filter elements further allows for a reduction of energy consumption of the cabin air filtration system.

From EP 1 985 351 A1 an air filter device is known which has a filter unit with a filter housing and a filter insert having a filter frame and a filter element. The filter element is equipped with a transponder and a reader for reading out the transponder is arranged in the filter unit or outside the filter unit. The data can relate to a type of the filter unit, performance data or technical data of the filter unit.

Similar systems with an RFID reader and an air filter bearing an RFID tag are known form WO 2018/031403 A1 or DE 20 2015 001 147 U1. Information retrieved from the RFID tag may be used for determining a remaining service life of the air filter.

US 2004/0065204 A1 describes an air quality monitoring arrangement of an enclosed cab of an agricultural tractor used for towing or carrying spraying implements for treating crop with substances which might be toxic or otherwise harmful to people. A signal from a contaminant sensor is sent to a control arrangement, which compares the actual sensed contamination of the air within the cab over time with a value from a performance map representing the performance expected from normal performance of the air circulating system of the cab. When the sensed contamination is higher than that of the performance map the operator is warned of a malfunction. The blower of the air circulating system may have its speed increased so as to pressurize the cab so as to exclude the entry of contaminated air through seals and other small openings of the cab. The air filters used are coded and recognized by the control system, which keeps track of the service time of the filters and warns an operator when the service time exceeds that of a stored time value related to the particular filter.

It is an object of the embodiments to improve air quality focused operation of a cabin air filtration system.

### SUMMARY

This is achieved by a method for operating a cabin air filtration system of a vehicle according to claim 1, an electronic control unit for a cabin air filtration system of a vehicle according to claim 17 and a cabin air filtration system according to claim 19. Advantageous embodiments are given in the subclaims and the description.

In accordance with the embodiments, a method for operating a cabin air filtration system of a vehicle is provided. For example, the vehicle may be a passenger car, a van or a bus.

The cabin air filtration system comprises an air filter device for filtering an air flow into the cabin. The air flow through the air filter device is composed of fresh air from outside and recirculated air from inside the cabin. In other words, fresh air from outside as well as recirculated air from inside the cabin are filtered in the air filter device and blown (back) into the cabin. The air filter device comprises at least one air filter element.

A magnitude of the air flow through the air filter device is adjustable. A blower device may be employed to this end. The magnitude of the air flow describes the amount of fresh and recirculated air which is filtered in the air filter device and may be measured as volume or mass per time.

A ratio of fresh air and recirculated air of the air flow through the air filter device is adjustable. As outlined above, the air flow through the air filter device is composed of fresh and recirculated air. The portion of these two components can be adjusted to be only fresh air, only recirculated air or some ratio in between. The adjustment of the recirculation ratio of fresh and recirculated air may be made continuously. A flow ratio adjustment device may be employed to this end.

The air filter device comprises at least one filter element. The air flow through the air filter device is directed through the filter element or at least one of the filter elements in order to remove contaminants such as particles. The filter element has a storage means. The storage means may be affixed to a filter medium, an end plate or a frame of the filter element. The storage means contains data comprising information characterizing the filter element.

The storage means may be an RFID-tag, an NFC-tag, or a graphical code such as a barcode or QR-code. A filter housing of the cabin air filtration system may comprise a reader for the storage means.

In a step A) of the method, data comprising information characterizing the filter element is retrieved from the filter element. The information may specify a type of the filter element. To this end, the information may comprise an identifier corresponding to a certain type or several similar types of filter elements. The information may comprise a serial number.

In a step B) of the method, system information is provided for the filter element, which is identified by the information retrieved in step A). The system information links at least one characteristic of the filter element comprising information on a filtration efficiency of the filter element, the magnitude of the air flow through the air filter device, the recirculation ratio of fresh and recirculated air, air property data referring to an air property inside and/or outside the cabin, and an air quality information which characterizes the air quality inside the cabin.

The system information may be obtained from experiments and/or simulations. The system information may be provided for different pollutants, i.e. the respective relation of the aforementioned values may be contained in the system information for different pollutants, such as particles of different size ranges and/or harmful gases. The system information describes functional interdependencies of the cabin air filtration system, which are particularly relevant. In particular, the filtration efficiency may describe the amount of a specific pollutant, which is held back in the filter element, i.e. removed from the air flow through the air filter device, at a certain operation state of the cabin air filtration system. The air quality information provided with the system information depends on the magnitude of the air flow through the air filter device, the recirculation ratio of fresh and recirculated air, and the air property data as variables. The information about the air quality may be a concentration of one or more pollutants in the air inside the cabin. The information about the air quality may be an aggregated air quality index. The air quality index is typically calculated using a formula combining amounts of different pollutants, such as for instance PM1, PM2.5, PM10, NO2, O3 and the number of fine and ultrafine particles. The air quality index could be based for instance on the US-EPA2016 standard.

In step B), the system information may be retrieved from the storage means. In other words, the storage means of the filter element provides the system information. This ensures that the right system information for the filter element is used. In this case, the information characterizing the filter element may be the system information, i.e. the filter element is characterized by the system information provided on its storage means.

Alternatively, in step B) the system information may be retrieved from an internal storage of an electronic control unit of the cabin air filtration system or from an external data base. This allows the use of a storage means with limited storage capacity. In the internal storage of the electronic control unit the system information may be provided independently from an internet connection or the like. Retrieving the system information from an external data base, such as a cloud storage, may facilitate updating the system information.

In a step C) of the method, current air property data referring to an air property inside and/or outside the cabin is retrieved. The current air property data serves as an input value for evaluating the system information in step D).

The air property data may be retrieved from at least one air property sensor of the cabin air filtration system. In particular, the cabin air filtration system may comprise an internal air property sensor and/or an external air property sensor. This allows obtaining particularly precise air property data.

Alternatively or additionally, the (outside) air property data may be retrieved from an environmental pollution measurement service. This variant reduces hardware cost for a vehicle with the cabin air filtration system.

In a step D) of the method, the air quality information which characterizes the air quality inside the cabin is determined from the system information for the current magnitude of the air flow, the current recirculation ratio of fresh and recirculated air and the current air property data. The information about the air quality inside the cabin may be used for controlling the operation of the cabin air filtration system. The determined air quality information which characterizes the air quality inside the cabin may in particular be a current air quality information which characterizes the current or momentary air quality inside the cabin.

Linked data as used herein may refer to data that is functionally related, for example, at least one characteristic of the air filter device (e.g., a data point of air quality information) may be related to specific magnitude of the air flow, ratio of fresh and recirculated air and an air property data. A plurality of such data points may be linked, e.g., in a database, a matrix, a multidimensional array, a map, a graph, or a combination thereof.

The act of providing, retrieving and/or determining may each be carried out by a computation system, e.g., an electronic control circuit comprising a processor, a server, and/or a cloud.

Additionally or alternatively, the information about the air quality inside the cabin, in particular the result of a comparison of the information about the air quality inside the cabin with a predefined target value, may be notified to a user of the vehicle. This allows the user to perceive the current efficacy of the cabin air filtration system. The target value may be set by the user according to his personal preference.

The information about the air quality inside the cabin may be compared with a target value, for example, different target values for different pollutants, in particular particulates of different size ranges and/or harmful gases. The target value may depend on a geo-localization of the vehicle and/or on a user input. The result of the comparison may be used for controlling the operation of the cabin air filtration system in order to comply with the target value(s), for example, while minimizing energy consumption of the cabin air filtration system.

In particular, the recirculation ratio of fresh and recirculated air may be adjusted based on the result of the comparison. Specifically, in predefined time intervals, the comparison may be performed, and the recirculation ratio of fresh and recirculated air may be adjusted accordingly. This ensures that the operation of the cabin air filtration system is always close to the optimum. The time interval is chosen such that the relevant input parameters typically do not change excessively between two successive evaluations. For example, the time interval may be selected to be at least 0,5 s and/or at most 10 s. In particular, the time interval may be 1 s.

The operation of the cabin air filtration system at the recirculation ratio according to the result of the comparison may be interrupted by periods of operation of the cabin air filtration system at an air recirculation ratio provided from a prioritized strategy, in particular for defogging, defrosting, speed venting or energy saving.

According to various embodiments, the air filter device may comprise at least one basic filter element for filtering the fresh air and/or the recirculated air, and at least one HEPA filter element and/or an ambient air filter element for filtering the fresh air.

The HEPA filter element allows achieving a particularly good air quality inside the cabin. The ambient filter element can protect the HEPA filter element from large particles and extend its service life.

Fresh air from outside may selectively be directed to pass through or bypass the HEPA filter element and/or the ambient air filter element. Typically, the ambient air filter element is located upstream the HEPA filter element. The basic filter element and/or the ambient air filter element may comprise at least one adsorbent, in particular activated carbon. The adsorbent may remove harmful gases or odors from the filtered air. Activated carbon is particular efficient in this regard.

It may be provided, that the fresh air flow from outside passes or bypasses the HEPA filter element and/or the ambient air filter element depending on the result of the comparison of the information about the air quality inside the cabin with the at least one target value. In this way, the HEPA filter element and/or ambient filter element are only used, if necessary, in order to meet the air quality target. Bypassing these filter elements whenever possible, extends their service life and reduces energy consumption.

According to various embodiments, the at least one characteristic of the air filter device may further comprise information on an efficiency curve of a filter medium of the filter element, a type of the filter medium, a pressure loss of the filter element depending on the magnitude of the air flow through the air filter device, and/or a pollutant accumulation capacity, in particular a dust capacity, of the filter element.

The efficiency curve may be given for different pollutants, e.g. particles of different sizes and/or different concentrations of harmful gases. If the air filter device comprises a plurality of filter elements, an efficiency curve may be given for the filter medium of each of the respective filter elements. The type of the filter medium may specify if the air filter medium contains nano fibers and/or an adsorbent such as activated carbon; it may also specify a HEPA class of the filter medium. The pressure loss may be given dependent on an (expected) dust load of the filter medium. This additional information can be used for a particularly precise control of the cabin air filtration system.

The system information may comprise a multidimensional data array with the air quality information as an output value. The other parameters (e.g. magnitude of the air flow through the air filter device, recirculation ratio, air property data) of the data array serve as input parameters, i.e. the data array is evaluated for the current values of these parameters. In this way, the system information may readily be established and evaluated. Typically, the data array is stored in an electronic control unit of the cabin air filtration system. The data array may be represented in form of maps or characteristic diagrams.

According to various embodiments, an interpolation scheme may be used for determining the air quality information from the multidimensional data array. This allows for an efficient and precise evaluation of the system information, if an input value (e.g. magnitude of the air flow, recirculation ratio, air property data) deviates from the values with which the data array was created.

In an advantageous variant of the method, a remaining service life of the filter element is determined. This allows for a timely exchange of the filter element while exploiting its filtration capacity to a high degree. The pollutant accumulation capacity and a previous operation time of the filter element may be considered to this end. According to various embodiments a measurement of an air property sensor, in particular an external air property sensor, of the cabin air filtration system may be considered for determining the remaining service life. The remaining service life may be notified to a user of the vehicle.

A variant of the method is characterized in that the system information provided in step B) also links the vehicle speed to the air quality information and that the current vehicle speed is considered in step D) for determining the information about the air quality inside the cabin. This allows considering the effect of unfiltered infiltration of air from outside into the cabin, e.g. through seals of openings (such as doors or windows), wires or hoses.

The system information may consider an age of the vehicle and/or an age of a filter element of the air filter device. Upon aging, the leakage from outside which bypasses the air filter device may increase and/or a filtration efficiency of the air filter device may decrease. These effects can be established beforehand and implemented in the system information in order to ensure the best possible operation conditions of the cabin air filtration system, even after the vehicle or air filter device has undergone degradation.

According to various embodiments, step A) may be repeated each time the vehicle is started and step B) may be repeated at least when the information retrieved in repeated step A) differs from the information retrieved in the previous execution of step A). In particular, step B) may be repeated each time the vehicle is started. This variant of the method ensures that system information is always up to date. In particular, replacement of the previously installed filter element by a different type of filter element will be recognized and accounted for by retrieving the corresponding system information.

The method may comprise determining that the information retrieved in step A) differs from the information retrieved in the previous execution step A) and repeating step B).

An advantageous variant of the method is characterized in that after step A), it is checked if the filter element is suitable for the cabin air filtration system, and that if the filter element is suitable, steps B) to D) are performed. If the filter element is not suitable, the cabin air filtration system is operated in emergency mode and/or the unsuitability of the filter element is notified to a user of the vehicle.

The notification may urge the user to replace the unsuitable filter element with a suitable filter element. The notification may be made in a display of the vehicle and/or via a smartphone app of the user. A link for online purchase of a suitable filter element may be provided with the notification.

In the emergency mode, the determination of an information about the air quality inside the cabin and a remaining service life is generally not possible. Thus, this information cannot be notified to the user.

If the air filter device comprises a basic filter element and further filter elements, such as an HEPA filter element and/or an ambient air filter element, the air flow may be directed to pass through all these filter elements in the emergency mode. This ensures best air quality inside the cabin. Alternatively, the emergency mode may provide that the air flow is only directed to pass through the basic filter element and to bypass all of the further filter elements. This reduces energy consumption and saves the service life of the further filter elements, such as the expensive HEPA filter element.

The embodiments further relate to a use of a filter element in a cabin air filtration system of a vehicle, wherein the cabin air filtration system comprises an air filter device for filtering an air flow into the cabin, which air flow is composed of fresh air from outside and recirculated air from inside the cabin, wherein a magnitude of the air flow through the air filter device is adjustable, and wherein a ratio of fresh air and recirculated air of the air flow through the air filter device is adjustable. According to the embodiments, the filter element has a storage means, which comprises system information for the filter element, which system information links at least one characteristic of the filter element comprising information on a filtration efficiency of the filter element, the magnitude of the air flow through the air filter device, the recirculation ratio of fresh and recirculated air, air property data referring to an air property inside and/or outside the cabin, and an air quality information which characterizes the air quality inside the cabin.

In other words, the system information to be used in the above-described inventive method is provided with the filter element. The filter element with the system information contained in its storage means facilitates execution of this method. In particular, the filter element allows the system information to be retrieved from the storage means in step B) of the method. This ensures that the right system information for the filter element is used.

According to various embodiments, the at least one characteristic of the filter element may further comprise information on an efficiency curve of a filter medium of the filter element, a type of the filter medium, a pressure loss of the filter element depending on the magnitude of the air flow through the air filter device, and/or a pollutant accumulation capacity, in particular a dust capacity, of the filter element.

The efficiency curve may be given for different pollutants, e.g. particles of different sizes and/or different concentrations of harmful gases. If the air filter device comprises a plurality of filter elements, an efficiency curve may be given for the filter medium of each of the respective filter elements. The type of the filter medium may specify if the air filter medium contains nano fibers and/or an adsorbent such as activated carbon; it may also specify a HEPA class of the filter medium. The pressure loss may be given dependent on an (expected) dust load of the filter medium. This additional information can be used for a particularly precise control of the cabin air filtration system.

It may be provided, that the storage means is an RFID-tag, an NFC-tag, or a graphical code, in particular a barcode or a QR-code. Such a storage means is inexpensive and easy to read out.

Furthermore, the embodiments relate to an electronic control unit for a cabin air filtration system of a vehicle, wherein the cabin air filtration system comprises an air filter device for filtering an air flow into the cabin, which air flow is composed of fresh air from outside and recirculated air from inside the cabin, wherein a magnitude of the air flow through the air filter device is adjustable, wherein a ratio of fresh air and recirculated air of the air flow through the air filter device is adjustable, and wherein the air filter device comprises at least one filter element having a storage means.

The electronic control unit is configured to retrieve current air property data referring to an air property inside and/or outside the cabin. Further, the electronic control unit is configured to determine for the current magnitude of the air flow, the current recirculation ratio of fresh and recirculated air and the current air property data an information about an air quality inside the cabin from system information which links at least one characteristic of the filter element comprising information on a filtration efficiency of the filter element, the magnitude of the air flow through the air filter device, the recirculation ratio of fresh and recirculated air, air property data referring to an air property inside and/or outside the cabin, and an air quality information which characterizes the air quality inside the cabin.

In other words, the electronic control unit is configured to perform steps C) and D) of the method according to the embodiments as described above. The control unit allows for execution of the method according to the embodiments in a convenient and efficient way.

In a first embodiment, the electronic control unit is configured to retrieve the system information. For instance, the electronic control unit may be configured to retrieve the system information from the storage means of the filter element, in particular wherein the filter element is an above-described filter element according to the embodiments. Alternatively, the electronic control unit may be configured to retrieve the system information from an external data base, such as a cloud storage.

In a second embodiment, the electronic control unit comprises the system information. In particular, the system information may be stored in an internal storage of the electronic control unit. Different sets of system information may be provided in the internal storage for different suitable filter elements.

The embodiments also relate to a cabin air filtration system comprising an air filter device for filtering an air flow into a cabin of a vehicle, which air flow is composed of fresh air from outside and recirculated air from inside the cabin; a blower device for adjusting a magnitude of the air flow through the air filter device; a flow ratio adjustment device for adjusting a ratio of fresh air and recirculated air of the air flow through the air filter device; a filter element having a storage means, which comprises information characterizing the filter element; a reader for the storage means; and an above-described electronic control unit according to the embodiments.

The cabin air filtration may be used to perform the method according to the embodiments.

The storage means may be an RFID-tag, an NFC-tag, or a graphical code such as a barcode or QR-code. The reader may be an RFID-reader, an NFC-reader or a graphical code reader, in particular a barcode reader or a QR-code reader.

Generally, the filter element is installed in a filter housing of the air filter device. The reader may be attached to the filter housing.

The filter element may be an above-described filter element according to the embodiments, i.e., the system information may be comprised in the storage means.

### BRIEF DESCRIPTION OF DRAWINGS

Other advantages and features of the embodiments will be appreciated from the following description with reference to the figures of the drawing, which show significant details, and from the claims. The individual features, as described above or explained below, may each be implemented individually or implemented together in any useful combination in variants of the embodiments.

FIG. 1 shows a vehicle having a cabin air filtration system with a basic filter element, a HEPA filter element and an ambient air filter element each having a storage means carrying information on the respective filter element, and wherein system information relating to the installed filter elements is used to determine an information about the air quality inside the cabin according to the embodiments, in a schematic sketch.

FIG. 2 shows the vehicle from FIG. 1, wherein the fresh air passes through the ambient air filter element and the basic filter element and bypasses the HEPA filter element, in a schematic sketch.

FIG. 3 shows a schematic flow chart of a method for operating a cabin air filtration system according to the embodiments, wherein system information is retrieved from a storage means of a filter element.

FIG. 4 shows a schematic flow chart of a method for operating a cabin air filtration system according to the embodiments, wherein system information is retrieved from an external data base.

### DETAILED DESCRIPTION

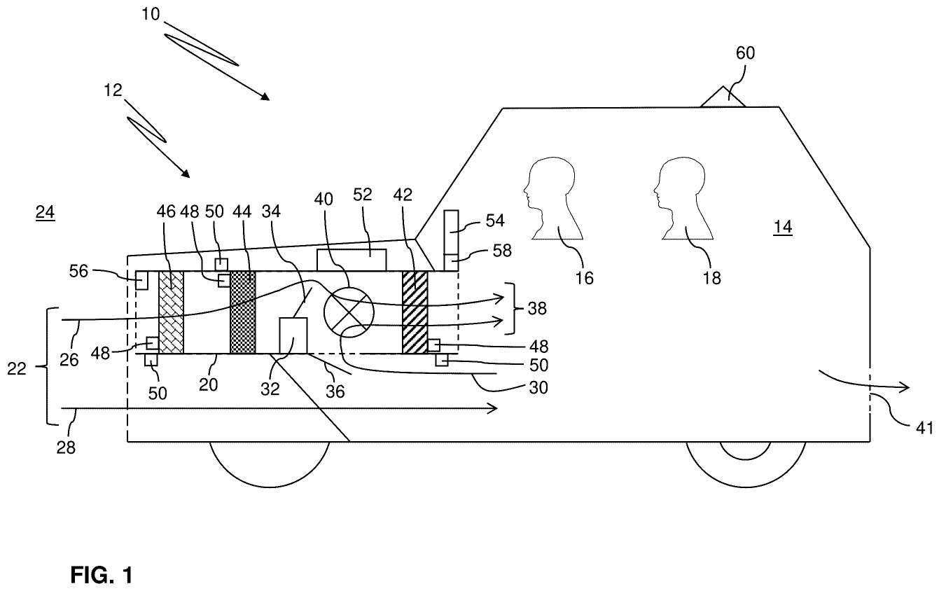

FIG. 1 shows a vehicle 10. The vehicle comprises a cabin air filtration system 12. Inside the vehicle 10, a cabin 14 is formed. Users 16, 18 of the vehicle 10 are seated in the cabin 14.

The cabin air filtration system 12 has an air filter device 20. A total influx 22 of fresh air from an outside environment 24 enters the cabin as a filtered influx 26, which passes through the air filter device 20, and as an unfiltered infiltration influx 28, which bypasses the air filter device 20. The magnitude of the unfiltered infiltration influx depends in particular on the vehicle speed.

Air from inside the cabin 14 is recirculated in a recirculation air flow 30 through the air filter device 20. A flow ratio adjustment device 32 is provided to adjust the ratio of the recirculation air flow 30 and filtered influx 26. The flow ratio adjustment device 32 is depicted here schematically with to movable flaps 34, 36.

The filtered influx 26 and the recirculation air flow 30 together present a filtered air flow 38 through the air filter device 20. A blower device 40 is provided to adjust a magnitude of the air flow 38, which passes through the air filter device 20. The magnitude may be given as volume or mass of air per time. The magnitude of the air flow 38 may be measured by a flow meter (not depicted).

Alternatively, the magnitude of the air flow may be estimated. To this end, a voltage and current applied to the blower device 40 may be measured. Furthermore, the temperature of the air in the outside environment 24 may be measured. The density of the air outside may be measured or calculated from the temperature. Likewise, the temperature and density of the air inside the cabin 14 may be measured and/or calculated. Using this dataset the volumetric and/or mass flow rate through the blower device 40 can be determined.

Air from inside the cabin 14 may exit the cabin at one or more decompression outlets 41. An excessive increase of the pressure inside the cabin 14, especially at higher speeds, is thereby prevented. Further, decompressing the cabin 14 reduces the energy consumption of the blower device 40 to blow a sufficient amount of fresh air into the cabin 14.

In the depicted embodiment, the air filter device 20 comprises a basic filter element 42, a HEPA filter element 44 and an ambient air filter element 46. The basic filter element 42 and the ambient air filter element 46 may be equipped with an adsorbent such as activated carbon. Here, the recirculation air flow 30 passes solely through the basic filter element 42. The filtered influx 26 may successively pass through the ambient air filter element 46, the HEPA filter element 44 and the basic filter element 42.

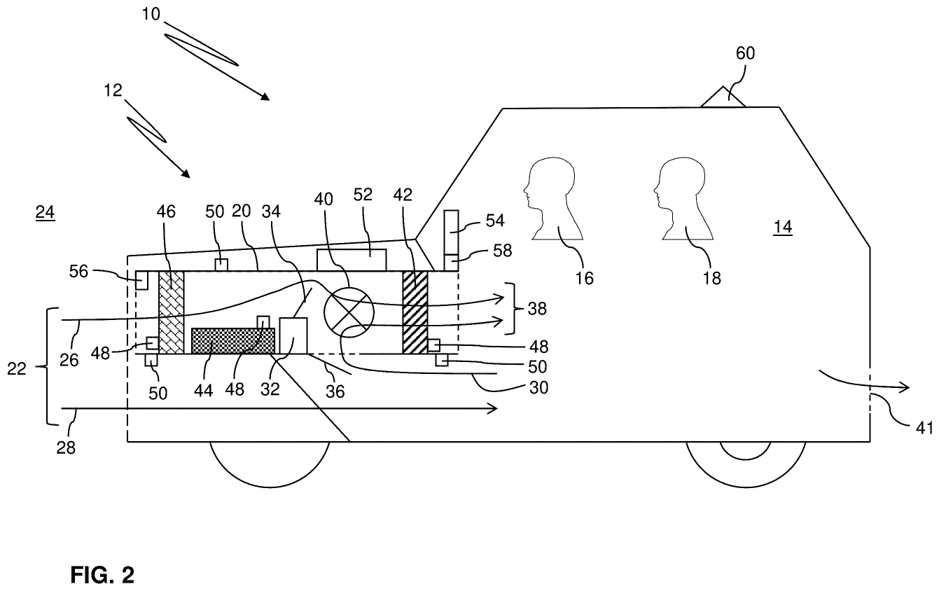

A bypass function for the filtered influx 26 from outside may be provided with regard to the ambient air filter element 46 or the HEPA filter element 44. As schematically depicted in FIG. 2, the filtered influx might for instance pass through the ambient air filter element 46 and the basic filter element 42, while bypassing the HEPA filter element 44.

At least one of the filter elements, generally the basic filter element 42, the HEPA filter element 44 and the ambient air filter element 46, are (each) equipped with a storage means 48. The storage means 48 could be an RFID-chip, which might be attached to a frame of the respective filter element 42, 44, 46.

The air filter device 20 has at least on reader 50 for reading information stored in the storage means 48 of the filter elements 42, 44, 46. Here, a separate reader 50 for each of the filter elements 42, 44, 46 is mounted on a housing of the air filter device 20. In the depicted embodiment, the readers 50 are each RFID-readers.

The cabin air filtration system 12 comprises an electronic control unit 52. The electronic control unit 52 is configured to operate the cabin air filtration system 12 according to the embodiments. The electronic control unit 52 evaluates the information read by the readers 50 from the storage means 48. The electronic control unit 52 further serves to control the magnitude of the air flow 38 through the air filter device 20 and the recirculation ratio, i.e. the magnitude of the recirculation air flow 30 divided by the magnitude of the filtered influx 26.

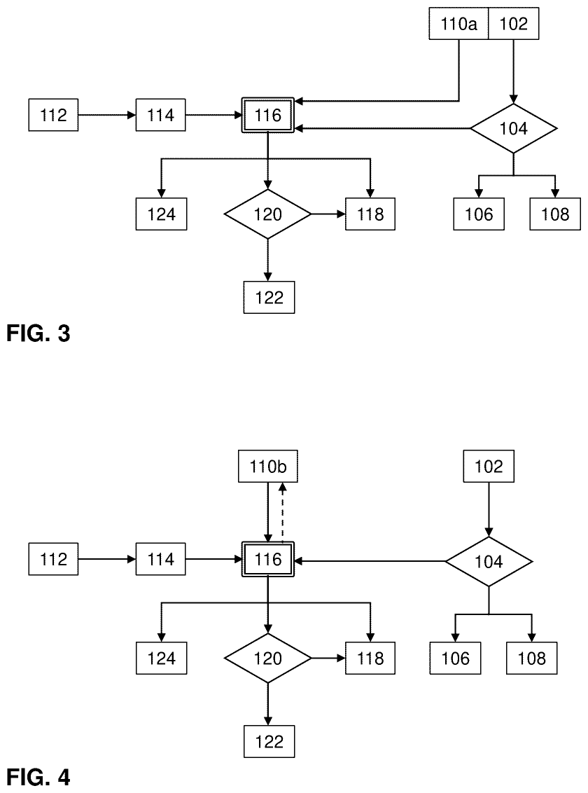

A flow chart of a method for operating the cabin air filtration system 12 according to the embodiments is depicted in FIG. 3.

In a step 102, data comprising information, which characterizes the filter element or the filter elements 42, 44, 46 respectively, is retrieved. To this end, the content of the storage means 48 is read by the readers 50. Step 102 may be performed each time the vehicle 10 is started.

In a step 104, it is checked if the installed filter elements 42, 44, 46 are suitable for the cabin air filtration system 12. This may be judged based on a serial number or part number which is read from the storage means 48.

If the filter element or at least one of the filter elements 42, 44, 46 is not suitable, the electronic control unit 52 may notify the driver 16 in a step 106, e.g. via an input-output device 54 such as a touchscreen. Furthermore, the electronic control unit 52 may switch to an emergency mode in a step 108. In a first variant of the emergency mode, the HEPA filter element 44 might always be active in order to maintain best air quality inside the cabin 14. In an alternative variant of the emergency mode, the HEPA filter element 44 might always be bypassed, in order to reduce energy consumption and extend the service life of the HEPA filter element 44.

If the filter elements 42, 44, 46 are suitable, system information for the cabin air filtration system 12 with the installed filter elements 42, 44, 46 is considered. As depicted in FIG. 3, the system information may be retrieved in a step 110a from the storage means 48 via the readers 50.

According to the embodiment depicted in FIG. 4, the system information may be retrieved in a step 110b from an external data base, such as a cloud storage. The information which was retrieved in step 102 is used to identify the installed filter element(s) 42, 44, 46 and to retrieve the corresponding system information. Alternatively, it might be provided, that the system information is retrieved from an internal storage of the electronic control unit 52 using the information which was retrieved in step 102.

Besides the procedures for retrieving the system information, the operation methods sketched in FIGS. 3 and 4 do not differ.

The system information links at least one characteristic of the filter element(s) 42, 44, 46 comprising information on a filtration efficiency of the filter element(s) 42, 44, 46, the magnitude of the air flow 38 through the air filter device 20, the recirculation ratio of fresh and recirculated air, air property data referring to an air property inside and/or outside the cabin 14, and an air quality information which characterizes the air quality inside the cabin 14.

The at least one characteristic of the filter element 42, 44, 46 may further comprise information on an efficiency curve of a filter medium of the filter element(s) 42, 44, 46, a type of the filter medium of the respective filter element(s) 42, 44, 46, a pressure loss of the filter element(s) 42, 44, 46 depending on the magnitude of the air flow 38 through the air filter device 20, and a pollutant accumulation capacity, in particular a dust capacity, for example, for each of the basic, HEPA and ambient air filter elements 42, 44, 46.

Note, that the effect of an open window or sunroof might be considered in the system information.

In a step 112, current air property data referring to an air property inside and/or outside the cabin 14 are retrieved. The air property data can be obtained from an external air property sensor 56 or a cabin air property sensor 58 of the cabin air filtration system 12. External air property data might also be retrieved from a public pollution measurement service based on the geo-localization of the vehicle 10. A GPS-antenna 60 may serve to establish the geo-localization of the vehicle 10.

In a step 114, the electronic control unit 52 is provided with data referring to a current operational state of the vehicle 10 and in particular of the cabin air filtration system 12. This data comprises the information on the inside and/or outside air quality retrieved in step 112, the magnitude of the air flow 38 through the air filter device 20, the recirculation ratio of the fresh (filtered influx 26) and recirculated air (recirculation air flow 30), and optionally the vehicle speed.

Based on the data provided in step 114 and the system information retrieved in step 110a or 110b, respectively, the electronic control unit 52 determines in a step 116 an information about the air quality inside the cabin 14. In other words, the performance of the cabin air filtration system 12, which is described in the system information, is evaluated for the current operational state in order to provide an estimate of the air quality, which will be achieved inside the cabin 14, if the operation of the cabin air filtration system 12 will be continued at the currently set parameters.

The information about the air quality inside the cabin 14 may be given as an aggregated air quality index. In a step 118, the information about the air quality inside the cabin 14 may be notified to the users 16, 18 of the vehicle 10, e.g. via the input-output device 54.

A target value for the air quality may be predefined or set by a user 16, 18 of the vehicle 10, e.g. via the input-output device 54. Different target values may be predefined for different geographical regions, e.g. in order to comply with local laws or to meet local user requirements.

In a step 120, the information about the air quality inside the cabin 14, which was determined in step 116, may be compared to the target value. The result of the comparison may also be notified to the users 16, 18, cf. step 118.

Based on the result of the comparison, at least one operational parameter of the cabin air filtration system 12 may be adjusted in a step 122. For instance, the ratio of fresh and recirculated air may be altered, especially if the target value is not met. If the target value is met, it might be decided to bypass the HEPA filter element 44. If the target value is not met, the HEPA filter element 44 can be utilized.

The electronic control unit 52 may monitor the duration of use of the installed filter element(s) 42, 44, 46. Based on the operational conditions (in particular the (outside) air quality, the magnitude of the filtered air flow 38, and the recirculation ratio) and the system information (in particular the pollutant accumulation capacity of the filter element(s) 42, 44, 46) the electronic control unit 52 may determine a remaining service life of the filter element(s) 42, 44, 46 in a step 124. This may be notified to a user 16, 18 of the vehicle 10.

In summary, the embodiments refer to a method for operating a cabin air filtration system (12) with an air filter device (20) for filtering an air flow (38) into the cabin (14). The air filter device comprises at least one filter element (42, 44, 46) having a storage means (48).

The method comprises the steps: A) retrieving from the storage means of the filter element data comprising information characterizing the filter element; and B) providing system information for the filter element identified by the information retrieved in step A). The system information links at least one characteristic of the filter element comprising information on a filtration efficiency of the filter element, a magnitude of the air flow through the air filter device, a recirculation ratio of fresh and recirculated air of the air flow through the air filter device, air property data referring to an air property inside and/or outside the cabin, and an air quality information which characterizes the air quality inside the cabin. The method further comprises the step: C) retrieving current air property data referring to an air property inside and/or outside the cabin; and D) determining from the system information for the current magnitude of the air flow, the current recirculation ratio of fresh and recirculated air and the current air property data an information about the air quality inside the cabin.

1. A method for operating a cabin air filtration system of a vehicle,
wherein the cabin air filtration system comprises an air filter device for filtering an air flow into a cabin, the air flow being composed of fresh air from outside and recirculated air from inside the cabin,
wherein a magnitude of the air flow through the air filter device is adjustable,
wherein a ratio of the fresh air and the recirculated air is adjustable,
wherein the air filter device comprises at least one filter element comprising a storage, and
wherein the method comprises:
retrieving, from the storage of the filter element, data comprising information characterizing the filter element;
providing system information for the filter element identified by the retrieved data, the system information linking:
at least one characteristic of the filter element comprising information on a filtration efficiency of the filter element;
the magnitude of the air flow through the air filter device;
the ratio of the fresh air and the recirculated air;
air property data referring to an air property inside and/or outside the cabin; and
an air quality information characterizing an air quality inside the cabin;
retrieving current air property data referring to the air property inside and/or outside the cabin; and
determining a current air quality information about a current air quality inside the cabin, from the system information for a current magnitude of the air flow, a current recirculation ratio of the fresh air and the recirculated air and the current air property data.

2. The method according to claim 1, wherein the system information is provided from the storage.

3. The method according to claim 1, wherein the system information is provided from an internal storage of an electronic control unit of the cabin air filtration system or from an external data base.

4. The method according to claim 1, wherein the current air quality information is output to a user interface for notifying to a user of the vehicle.

5. The method according to claim 1, further comprising comparing the current air quality information with a target value.

6. The method according to claim 5, further comprising adjusting the current recirculation ratio of the fresh air and the recirculated air, based on a result of the comparison.

7. The method according to claim 1, wherein the air filter device comprises:
at least one basic filter element for filtering the fresh air and/or the recirculated air; and
at least one HEPA filter element and/or an ambient air filter element for filtering the fresh air.

8. The method according to claim 5, wherein the air filter device comprises:
at least one basic filter element for filtering the fresh air and/or the recirculated air; and
at least one HEPA filter element and/or an ambient air filter element for filtering the fresh air, and
wherein the fresh air from outside passes or bypasses the HEPA filter element and/or the ambient air filter element, depending on a result of the comparison.

9. The method according to claim 1, wherein the current air property data is retrieved from at least one air property sensor of the cabin air filtration system.

10. The method according to claim 1, wherein the current air property data is retrieved from an environmental pollution measurement service.

11. The method according to claim 1, wherein the at least one characteristic of the filter element further comprises information on any one or any combination of:
an efficiency curve of a filter medium of the filter element;
a type of the filter medium;
a pressure loss of the filter element depending on the magnitude of the air flow through the air filter device; and
a pollutant accumulation capacity of the filter element.

12. The method according to claim 1, wherein the system information comprises a multidimensional data array with the air quality information as an output value.

13. The method according to claim 1, further comprising determining a remaining service life of the filter element.

14. The method according to claim 1, wherein the system information also links a vehicle speed to the air quality information, and
wherein a current vehicle speed is considered for the determining the current air quality information.

15. The method according to claim 1, wherein the retrieving the data is repeated each time the vehicle is started, and
wherein the providing the system information is repeated at least when the retrieved data in a current execution of the retrieving the data differs from the retrieved data in a previous execution of the retrieving the data.

16. The method according to claim 1, further comprising:
after the retrieving the data, checking whether the filter element is suitable for the cabin air filtration system;
if the filter element is checked to be suitable, performing the providing the system information, the retrieving the current air property data and the determining the current air quality information; and
if the filter element is checked to be not suitable, operating the cabin air filtration system in an emergency mode and/or notifying an unsuitability of the filter element to a user of the vehicle.

17. An electronic control unit for a cabin air filtration system of a vehicle,
wherein the cabin air filtration system comprises an air filter device for filtering an air flow into a cabin, the air flow being composed of fresh air from outside and recirculated air from inside the cabin,
wherein a magnitude of the air flow through the air filter device is adjustable,
wherein a ratio of the fresh air and the recirculated air is adjustable,
wherein the air filter device comprises at least one filter element comprising a storage,
wherein the electronic control unit is configured to:
retrieve current air property data referring to an air property inside and/or outside the cabin; and
determine a current air quality information about a current air quality inside the cabin, from system information for a current magnitude of the air flow, a current recirculation ratio of the fresh air and the recirculated air and the current air property data, the system information linking:
at least one characteristic of the filter element comprising information on a filtration efficiency of the filter element;
the magnitude of the air flow through the air filter device;
the ratio of the fresh air and the recirculated air;
air property data referring to an air property inside and/or outside the cabin; and
an air quality information characterizing an air quality inside the cabin.

18. The electronic control unit according to claim 17, wherein the electronic control unit is further configured to retrieve the system information from the storage or from an external data base.

19. A cabin air filtration system comprising:
an air filter device for filtering an air flow into a cabin of a vehicle, the air flow being composed of fresh air from outside and recirculated air from inside the cabin;
a blower device for adjusting a magnitude of the air flow through the air filter device;
a flow ratio adjustment device for adjusting a ratio of fresh air and the recirculated air;
a filter element comprising a storage that comprises information characterizing the filter element; and
the electronic control unit according to claim 17.

20. The cabin air filtration system according to claim 19, further comprising a reader for the storage, the reader comprising a portable reader and/or a reader installed in the air filter device.
